(19) United States
(12) Patent Application Publication
(10) Pub. No.: US 2025/0341903 A1
(43) Pub. Date: Nov. 6, 2025

(54) ROTATION AND PRESS DETECTION USING STRAIN-BASED SENSORS

(71) Applicant: Qorvo US, Inc., Greensboro, NC (US)

(72) Inventor: Bryan Low, San Mateo, CA (US)

(21) Appl. No.: 19/175,048

(22) Filed: Apr. 10, 2025

Related U.S. Application Data
(60) Provisional application No. 63/641,481, filed on May 2, 2024.

(51) Int. Cl. G06F 3/038; G05G 1/015; G05G 1/02; G05G 1/10; G06F 3/02; G06F 3/0362

(52) U.S. Cl. CPC G06F 3/0383; G05G 1/015; G05G 1/02; G05G 1/10; G06F 3/0202; G06F 3/0362

(57) ABSTRACT

A user interface apparatus is disclosed with a housing, an exterior surface having a cylinder and first and second bumps, and an interior surface with aligned first and second strain sensors fixed to it. The strain sensors generate electrical signals when the respective bumps are depressed by a knob's rim protrusions. The knob is rotatably coupled to the distal end of the cylinder, allowing its protrusions to intermittently engage and depress the bumps as it is rotated around the cylinder. This interface provides an improved structure for detecting and responding to user input through rotation and depression of the knob in electronic devices. The radial distance between the center point of the cylinder and each bump allows this engagement and depression by the knob's protrusions during rotation.

### RELATED APPLICATIONS

This application claims the benefit of provisional patent application Ser. No. 63/641,481, filed May 2, 2024, the disclosure of which is hereby incorporated herein by reference in its entirety.

### FIELD OF THE DISCLOSURE

The present disclosure relates to input structures with sensors that detect strain, utilizing nearby stress concentration regions. These input structures are particularly useful for manually operated controls in electronic systems such as computers, cameras, and video games.

### BACKGROUND

Electronic devices that require waterproof housing and rotary interaction, such as a knob, require a method to seal the rotary device. O-rings or elastomer seals are sometimes used to seal rotary motion devices. These can degrade from wear and tear. Knobs with a button function can be a complex mechanical structure requiring multiple parts, and waterproofing inevitably adds more complexity to the knob assembly.

### SUMMARY

A user interface apparatus is disclosed having a housing with an interior surface and an exterior surface, a cylinder extending outwardly from the exterior surface, first and second bumps protruding from the exterior surface outside of the cylinder at different locations, and first and second strain sensors aligned with the first and second bumps and fixed to the interior surface. The strain sensors generate electrical signals when the respective bumps are depressed by a knob having a rim with a plurality of protrusions. The knob is rotatably coupled to the distal end of the cylinder such that it can be rotated around the cylinder while its protrusions intermittently engage and depress the first and second bumps. The radial distance between the center point of the cylinder and each bump is sufficient to allow this engagement and depression by the knob's protrusions as it is rotated around the cylinder. This user interface apparatus provides an improved structure for detecting and responding to user input through rotation and depression of the knob, which may be used in various applications that require user input such as electronic devices. The arrangement of the first and second strain sensors differentiate clockwise rotation, counterclockwise rotation, and press signals. These signals are the electrical signals generated as a result of the strain sensors being depressed when the first and second bumps are intermittently engaged by the plurality of protrusions on the rim of the knob that functions as a rotatable knob and pushbutton for a user to manipulate.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1A illustrates an exemplary embodiment of a user input apparatus having a housing with a knob detached for detailed view.

FIG. 1B illustrates the user input apparatus fully assembled.

FIG. 2 illustrates a detailed view of the knob with protrusions.

FIG. 3 illustrates strain sensor locations relative to the knob.

FIG. 4 illustrates a cross-section view of the knob protrusions engaging a bump in a rotation input action.

FIG. 5 illustrates a cross-section view of the knob engaging a bump in a push-button action.

FIG. 6 is a diagram showing how the disclosed user interface apparatus may interact with various types of electronic systems such as digital cameras and other types of user elements.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

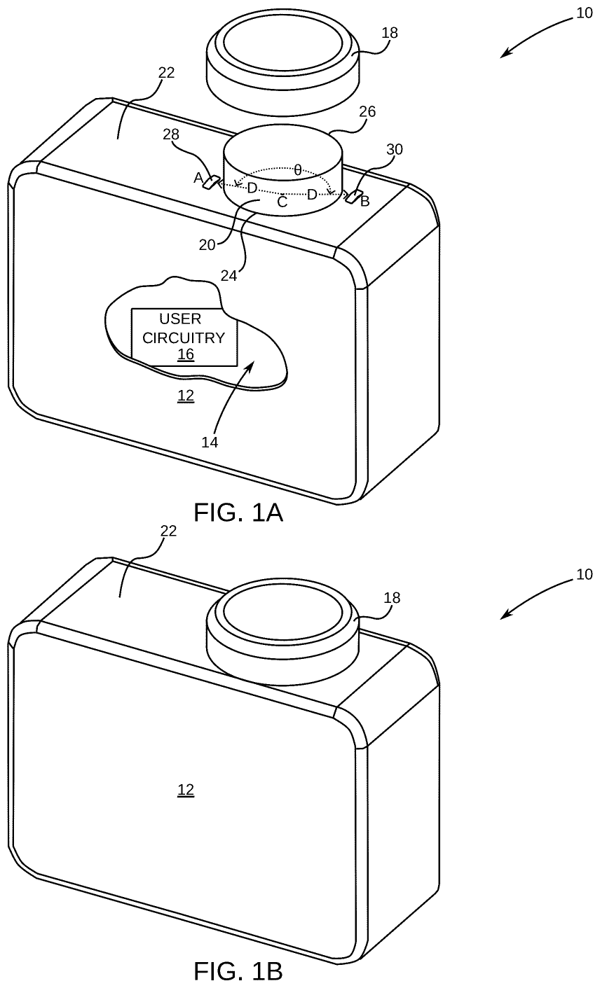

FIG. 1A is a diagram depicting an exemplary embodiment of a user interface apparatus 10 that includes a housing 12 that is generally a box shape with a substantially hollow interior 14 in which user circuitry 16 is housed. The housing 12 is hermetically sealed as shown in FIG. 1B to protect the user circuitry 16 from hazardous environments such as an underwater environment. In some embodiments the hollow interior 14 of the housing is waterproof to a water depth of up to 100 meters. In other embodiments, the housing is waterproof up to a water depth of 300 meters. The housing may be made of metal, plastic, and/or composite materials such as carbon fiber and resin.

The user interface apparatus 10 further includes a knob 18 that is configured to provide a manual input function for a user to interact with the user circuitry 16. FIG. 1A shows the knob 18 detached from a cylinder 20 that is coupled with an exterior surface 22 of the housing 12. The cylinder 20 extends outwardly from the exterior surface 22. The cylinder 20 has a proximal end 24 that is integral with the exterior surface 22 and a distal end 26 over which the knob 18 is rotatably attached. FIG. 1B shows the knob 18 rotatably attached to the cylinder 20, which is not visible in FIG. 1B.

Returning to FIG. 1A, a first bump 28 protrudes from the exterior surface 22 at a first bump point A that is radially spaced from a center point C of the cylinder 20 by a radial distance D. Similarly, a second bump 30 protrudes from the exterior surface 22 at a second bump point B that is angularly spaced from the first bump point A by an angle θ and radially spaced from the center point C of the cylinder 20 by the radial distance D. For example, the radial distance D may be 10 millimeters and the angle θ may be 180°.

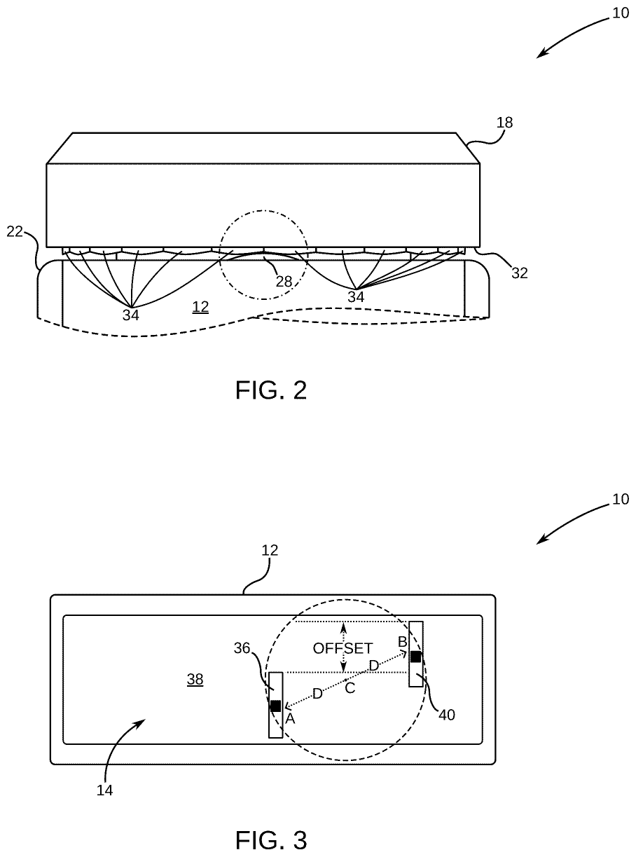

FIG. 2 shows a side view of the knob 18 in greater detail. The knob 18 has a rim 32 with a plurality of protrusions 34. The knob 18 is rotatable around the cylinder 20 (not visible) so that the plurality of protrusions 34 intermittently engages the first bump 28 and the second bump 30 (not visible) as the knob 18 is rotated around the cylinder 20. The radial distance D between the center point C (FIG. 1A) and the first and second bump points A and B is sufficient to allow the plurality of protrusions 34 to intermittently depress the first bump 28 and the second bump 30 as the knob 18 is rotated around the cylinder 20 in either of clockwise or counterclockwise directions. An engagement of the first bump 28 by one of the plurality of protrusions 34 is depicted within a dot-dash circle.

FIG. 3 is a bottom view looking into the hollow interior 14. In this view, a first strain sensor 36 is aligned with the first bump point A and fixed to an interior surface 38 of the housing 12. The first strain sensor 36 is configured to generate a first electrical signal as the first bump 28 is depressed. A second strain sensor 40 is aligned with the second bump point B and fixed to the interior surface 38 of the housing 12. The second strain sensor 40 is configured to generate a second electrical signal as the second bump 30 is depressed. The knob 18 is not visible in this view, but an envelope of the rim 32 is depicted by a dashed circle. Notice also an offset arrangement between the first strain gain 36 and the second strain sensor 40 depicted in FIG. 3. The offset arrangement assists in determining which of the clockwise and counterclockwise directions the knob 18 is being rotated during a user input. The use of the offset arrangement is detailed later in this disclosure.

For this disclosure, a strain sensor is defined as a type of mechanical transducer that converts the application of an external force into a change in electrical resistance. The sensing element is made up of a material with a specific electrical resistance that experiences a change in resistance when it is subjected to strain. The deformation caused by the applied force alters the geometry or microstructure of the sensing material, leading to a variation in its electrical resistance. This resistance change can be measured and calibrated to determine the level of strain or force being applied. Strain sensors suitable for use as the first strain sensor 36 and the second strain sensor 40 typically generate low-level direct current (DC) electrical signals, specifically, changes in resistance or voltage that are proportional to the amount of mechanical strain they experience. In this regard, a common type of strain sensor suitable as the first strain sensor 36 and second strain sensor 40 is the bonded metallic foil strain sensor, which consists of a relatively thin piece of metal foil arranged in a grid pattern and bonded to a substrate. When subjected to mechanical strain, the resistance of this metal foil changes due to a phenomenon called the piezoresistive effect. The resistance change is then converted into proportional electrical signals, usually in the form of a small change in voltage, using a bridge circuit and a voltage or current source. The resulting electrical signal is usually within a millivolt range and is typically processed using amplifiers and data acquisition systems and is used to determine the amount of strain or stress experienced by the first strain sensor 36 and the second strain sensor 40.

In some embodiments, the first strain sensor 36 and the second strain sensor 40 are each a printed ink strain gauge made up of a flexible substrate such as polyimide film or kapton, a conductive layer applied using printing techniques like inkjet or flexographic, an active layer with piezoresistive materials or other resistive elements also produced by printing, and connection pads for connecting the strain gauge to processing circuitry.

In yet other embodiments, the first strain sensor 36 and the second strain sensor 40 are each a micro-electromechanical systems (MEMS) strain sensor. The MEMS-type strain sensor is a relatively miniature sensor used to measure mechanical deformation or strain. Similar to the previous strain sensor type, the MEMS strain sensor operates based on the principle of piezoresistivity, where the resistance of the material changes in response to applied stress or strain. MEMS strain sensors are fabricated using semiconductor technology and are made up of thin-film resistive elements that undergo a change in resistance when deformed. Electrical signals representing strain are then measured/detected and processed to determine the magnitude and direction of the applied force applied to the first bump 28 and second bump 30. The knob 18 is configured to be manually rotated continuously clockwise and counterclockwise about the cylinder 20 and pressed against the first bump 28 and the second bump 30 to implement a pushbutton function.

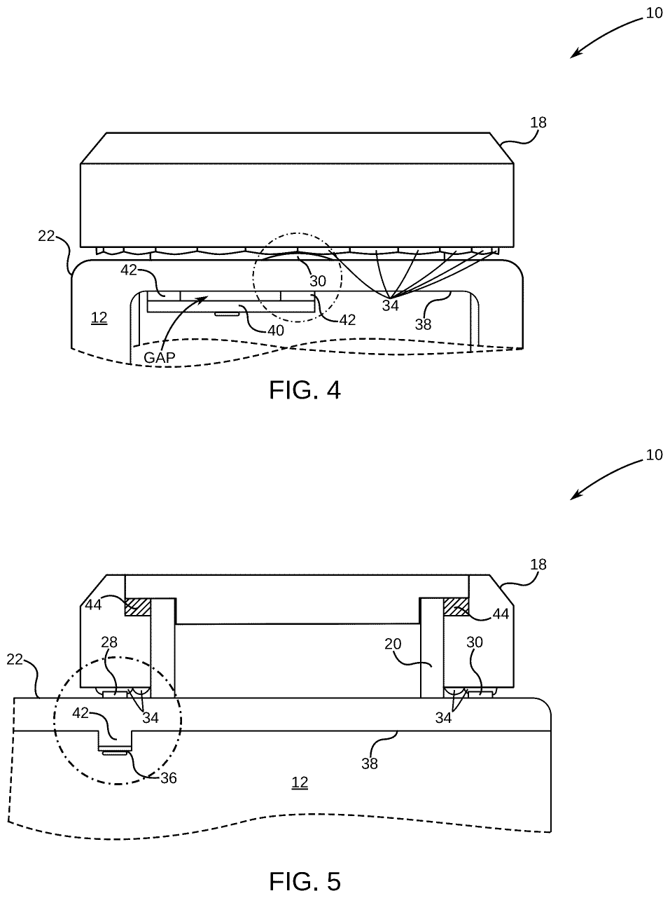

FIG. 4 is another cross-section view looking into the hollow interior 14 that shows the first strain sensor 36 (not visible) and the second strain sensor 40 to detect mechanical strain caused by deformations due to the engagement of the protrusions 34 with the first bump 28 (not visible) and the second bump 30 when the knob 18 is rotated around the cylinder 20 or pushed against the first bump 28 and second bump 30. The first strain sensor 36 (not visible) and the second strain sensor 40 are arranged and fixed to the interior surface 38 within the envelope of the rim 32 of the knob 18 by way of posts 42. A gap between a portion of the second strain sensor 40 and the interior surface 38 created by the posts 42 allows for greater deflection of the strain sensor 40 to mechanically amplify strain. An engagement of the second bump 30 by one of the plurality of protrusions 34 is depicted within a dot-dash circle. The depression force generated by this engagement of the second bump 30 is transmitted to the second strain sensor 40 through the post 42 directly under the second bump 30.

The offset arrangement depicted in FIG. 3 for the first strain sensor 36 and the second strain sensor 40 allows for a first deformation profile for a clockwise rotation of the knob 18 and a second deformation profile for a counterclockwise rotation of the knob 18. A third deformation profile is established for a press of the knob 18 against the first bump 28 and second bump 30 near simultaneously.

Table 1 shows exemplary first versions of the first deformation profile, the second deformation profile, and the third deformation generated by the first strain sensor labeled “Sensor 1” and the second strain sensor labeled “Sensor 2” whenever the knob 18, is rotated clockwise, counterclockwise, and pressed.

TABLE 1

| | Sensor 1 | Sensor 2 |
|---|---|---|
| | Response | Response |
| Clockwise Rotation | (−) Strain | (−) Strain |
| Counterclockwise Rotation | (−) Strain | (+) Strain |
| Press | (+) Strain | (+) Strain |

As listed in Table 1, the first version of the exemplary first deformation profile configured for clockwise rotation of the knob 18 shows a negative (−) strain response for sensor 1 and a negative strain response for sensor 2. The first version of the exemplary second deformation profile configured for counterclockwise rotation of the knob 18 shows a negative (−) strain response for sensor 1 and a positive (+) strain response for sensor 2. The first version of the exemplary third deformation profile configured for a press of the knob 18 shows a positive strain response for sensor 1 and a positive strain response for sensor 2.

Table 2 shows exemplary second versions of the first deformation profile, the second deformation profile, and the third deformation generated by the first strain sensor labeled “Sensor 1” and the second strain sensor labeled “Sensor 2” whenever the knob 18, is rotated clockwise, counterclockwise, and pressed.

TABLE 2

| | Sensor 1 | Sensor 2 |
|---|---|---|
| | Response | Response |
| Clockwise Rotation | (−) Strain | (+) Strain |
| Counterclockwise Rotation | (+) Strain | (−) Strain |
| Press | (+) Strain | (+) Strain |

As listed in Table 2, the second version of the exemplary first deformation profile configured for clockwise rotation of the knob 18 shows a negative (−) strain response for sensor 1 and a positive strain response for sensor 2. The second version of the exemplary second deformation profile configured for counterclockwise rotation of the knob 18 shows a positive strain response for sensor 1 and a negative strain response for sensor 2. The first and second versions of the exemplary third deformation profile configured for a press of the knob 18 are the same in this case, as Table 2 also shows a positive strain response for sensor 1 and a positive strain response for sensor 2. The positive strain response may, for example, generate a positive voltage signal; and the negative strain response may, for example, generate a negative voltage signal. The voltage signals may typically be in the range of millivolts but may be larger or smaller in magnitude depending on the type of strain sensors employed.

FIG. 5 illustrates a cross-section view of the knob 18 engaging the first bump 28 and the second bump 30 in a push-button action. The engagement of the first bump 28 is depicted within a dot-dash circle. The depression force generated by this engagement of the first bump 28 is transmitted to the first strain sensor 36 through the post 42 directly under the first bump 28. While not as clearly visible in the view presented by FIG. 5, the second bump is engaged nearly simultaneously in the push-button action. Also, visible in this cross-sectional view is an elastomer ring 44 that allows the knob 18 to rotate around the cylinder 20 while keeping the knob 18 rotatably coupled to the cylinder 20. In yet other embodiments, other fixing devices such as springs may be employed in place of the elastomer ring 44.

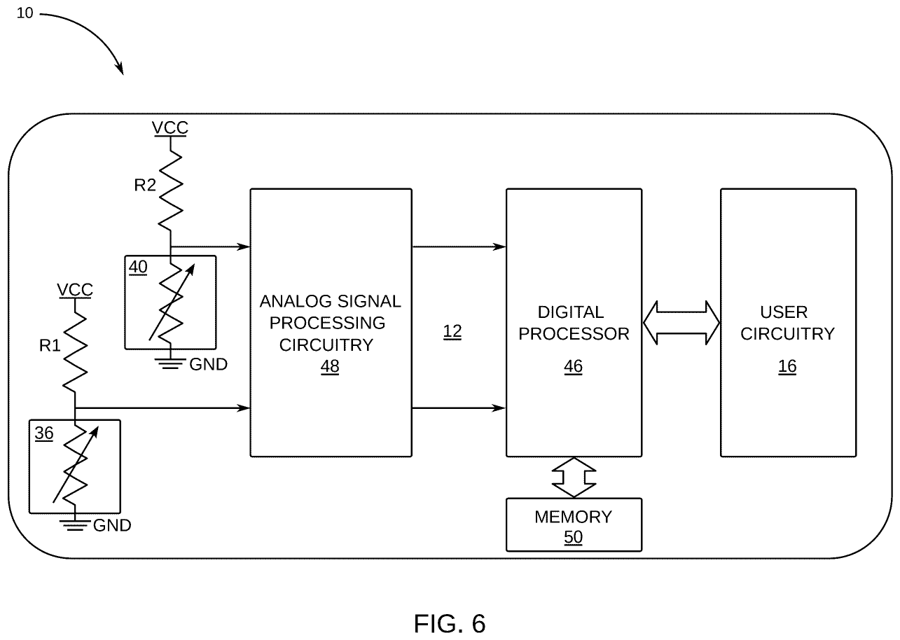

With reference to FIG. 6, the concepts described above may be implemented for various types of electronic systems such as the user circuitry 16 that may make up a digital camera controller, a game controller, a handheld pendent robot controller, and the like that require manual user input. The user circuitry 16 generally interfaces with or includes a digital processor 46 and analog signal processing circuitry 48 coupled between the first strain sensor 36, the second strain sensor 40, and the digital processor 46. A first resistor R1 and a second resistor R2 form voltage dividers between the first strain sensor 36 and the second strain sensor 40, respectively. The voltage dividers are both coupled between an excitation source VCC and a ground GND. The analog processing circuitry 48 typically includes amplifiers and filters (not shown) that cooperate to amplify and remove noise from the first electrical signal and the second electrical signal that are generated by the first strain sensor 36 and the second strain sensor 40 as a user rotates the knob 18 in either direction or presses down on the knob 18 to substantially simultaneously engage the first strain sensor 36 and the second strain sensor 40.

The digital processor 46 typically includes an analog-to-digital converter that converts amplified and filtered versions of the first and second electrical signals into first and second digital signals, respectively. The digital processor 46 then processes the first and second digital signals to extract the information that determines the direction the knob 18 is rotated and/or if the knob 18 is depressed to function as a push-button in accordance with the deformation profiles given in Table 1 and Table 2. This processing may also comprise error correction operations and other decoding such as the rate of rotation. The digital processor 46 may be implemented in one or more digital signal processors (DSPs) and application-specific integrated circuits (ASICs) and be interfaced with a memory 50 in which firmware is stored. The firmware includes instructions for controlling the processing that determines user input. Further signal processing details will be understood by those skilled in the art.

At least a first advantage of the user interface apparatus 10 is a reduction in complexity for realizing a waterproof device with a manual user input function. For example, the interface apparatus 10 does not require any openings to the housing and thus will not require any additional sealing because the housing is practically permanently hermetically sealed. At least a second advantage of the user interface apparatus 10 requires a relatively simple electronic system for processing user input that is reduced to the first strain sensor 36 and the second strain sensor 40, analog signal processing circuitry 48, and the digital processor 46 to differentiate output from the first strain sensor 36 and the second strain sensor 40.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A user interface apparatus comprising:
a housing having an interior surface and an exterior surface;
a cylinder having a proximal end that is integral with the exterior surface and a distal end, wherein the cylinder extends outwardly from the exterior surface;
a first bump protruding from the exterior surface outside of the cylinder at a first bump point that is radially spaced from a center point of the cylinder at the exterior surface by a radial distance;
a second bump protruding from the exterior surface outside of the cylinder at a second bump point that is angularly spaced from the first bump point and radially spaced from the center point of the cylinder at the exterior surface by the radial distance;
a first strain sensor aligned with the first bump point and fixed to the interior surface, wherein the first strain sensor is configured to generate a first electrical signal as the first bump is depressed;
a second strain sensor aligned with the second bump point and fixed to the interior surface, wherein the second strain sensor is configured to generate a second electrical signal as the second bump is depressed; and
a knob having a rim with a plurality of protrusions, wherein the knob is rotatably coupled to the distal end of the cylinder such that the knob is rotatable around the cylinder and the plurality of protrusions intermittently engage the first bump and the second bump as the knob is rotated around the cylinder, wherein the radial distance is sufficient to allow the plurality of protrusions to intermittently depress the first bump and the second bump as the knob is rotated around the cylinder.

2. The user interface apparatus of claim 1 further comprising analog signal processing circuitry coupled to outputs of the first and second strain sensors and configured to amplify and filter the first electrical signal and the second electrical signal.

3. The user interface apparatus of claim 1 further comprising a digital processor coupled to the analog circuitry and configured to determine a direction of the rotation of the knob based on the first electrical signal and the second electrical signal, wherein the digital processor compares the first electrical signal and the second electrical signal to a first deformation profile and a second deformation profile to determine the direction of rotation.

4. The user interface apparatus of claim 3 wherein the digital processor is further configured to detect a push of the knob by comparing the first electrical signal and the second electrical to a third deformation profile.

5. The user interface apparatus of claim 4 wherein the digital processor is coupled to user circuitry and is further configured to output the direction of the rotation of the knob to the user circuitry.

6. The user interface apparatus of claim 5 wherein the digital processor is further configured to output the detection of a push of the knob to the user circuitry.

7. The user interface apparatus of claim 1 wherein the first strain sensor and the second strain sensor are fixed to the interior surface by way of posts that provide a gap between the interior surface and a portion of each of the first strain sensor and the second strain sensor to mechanically amplify stress applied the first strain sensor and the second strain sensor when the first bump and the second bump are engaged by the plurality of protrusions.

8. The user interface apparatus of claim 1 wherein the housing is hermetically sealed.

9. The user interface apparatus of claim 8 wherein the housing is waterproof up to a water depth of 100 meters.

10. A method for interacting with a user interface apparatus having a housing with a cylinder extending outwardly from an exterior surface of the housing, first and second bumps protruding from the exterior surface and radially spaced from a center point of the cylinder, first and second strain sensors fixed to an interior surface of the housing and configured to generate first and second electrical signals as the first and second bumps are depressed, and a knob having a rim with a plurality of protrusions, the knob being rotatably coupled to the distal end of the cylinder such that the plurality of protrusions intermittently engage and depress the first and second bumps as the knob is rotated, the method comprising:
detecting the first electrical signal from the first strain sensor when the first bump is depressed by a protrusion; and
detecting the second electrical signal from the second strain sensor when the second bump is depressed by a protrusion, wherein each detected electrical signal is indicative of an interaction with the user interface apparatus at the corresponding bump.

11. The method for interacting with the user interface apparatus of claim 10 further comprising detecting a direction of knob rotation based on a first deformation profile.

12. The method for interacting with the user interface apparatus of claim 10 further comprising detecting a direction of knob rotation based on a second deformation profile.

13. The method for interacting with the user interface apparatus of claim 10 further comprising detecting a push of the knob based on a third deformation profile.

14. The method for interacting with the user interface apparatus of claim 10 wherein the first strain sensor and the second strain sensor are fixed to the interior surface by way of posts that provide a gap between the interior surface and a portion of each of the first strain sensor and the second strain sensor, the method further comprising mechanically amplifying stress applied the first strain sensor and the second strain sensor when the first bump and the second bump are engaged by the plurality of protrusions.

15. An electronic system for processing user input, comprising:
a user interface apparatus configured to generate a first electrical signal and a second electrical signal from a first strain sensor and a second strain sensor that are stressed by a knob configured to be rotated and pressed manually by a user;
analog signal processing circuitry coupled to the user interface apparatus and configured to amplify and filter the first electrical signal and the second electrical signal;
a digital processor coupled to the analog signal processing circuitry, the digital processor comprising an analog-to-digital converter for converting amplified and filtered versions of the first and second electrical signals into first and second digital signals, respectively, and further configured to process the first and second digital signals to extract information that determines the direction the knob is rotated in a knob rotation function and/or if the knob is depressed to function as a push-button, the processing further comprising error correction operations and other decoding such as the rate of rotation.

16. The electronic system of claim 15 wherein the user interface apparatus further comprises:
a housing having an interior surface and an exterior surface;
a cylinder having a proximal end that is integral with the exterior surface and a distal end, wherein the cylinder extends outwardly from the exterior surface;
a first bump protruding from the exterior surface outside of the cylinder at a first bump point that is radially spaced from a center point of the cylinder at the exterior surface by a radial distance;
a second bump protruding from the exterior surface outside of the cylinder at a second bump point that is angularly spaced from the first bump point and radially spaced from the center point of the cylinder at the exterior surface by the radial distance;
the first strain sensor aligned with the first bump point and fixed to the interior surface, wherein the first strain sensor is configured to generate a first electrical signal as the first bump is depressed;
the second strain sensor aligned with the second bump point and fixed to the interior surface, wherein the second strain sensor is configured to generate a second electrical signal as the second bump is depressed; and
the knob having a rim with a plurality of protrusions, wherein the knob is rotatably coupled to the distal end of the cylinder such that the knob is rotatable around the cylinder and the plurality of protrusions intermittently engage the first bump and the second bump as the knob is rotated around the cylinder, wherein the radial distance is sufficient to allow the plurality of protrusions to intermittently depress the first bump and the second bump as the knob is rotated around the cylinder.

17. The electronic system of claim 16 wherein the first strain sensor and the second strain sensor are fixed to the interior surface by way of posts that provide a gap between the interior surface and a portion of each of the first strain sensor and the second strain sensor to mechanically amplify stress applied the first strain sensor and the second strain sensor when the first bump and the second bump are engaged by the plurality of protrusions.

18. The electronic system of claim 16 wherein the housing is hermetically sealed.

19. The electronic system of claim 18 wherein the housing is waterproof up to a water depth of 100 meters.

20. The electronic system of claim 18 wherein the housing is waterproof up to a water depth of 300 meters.
